(19) United States
(12) Patent Application Publication
(10) Pub. No.: US 2024/0351649 A1
(43) Pub. Date: Oct. 24, 2024

(54) WALKING ROBOT

(71) Applicant: PTT EXPLORATION AND PRODUCTION PUBLIC COMPANY LIMITED, Bangkok (TH)

(72) Inventors: Suppachai PEWKLIANG, Bangkok (TH); Poramate MANOONPONG, Rayong (TH); Thirawat CHUTHONG, Rayong (TH); Nat DILOKTHANAKUL, Rayong (TH); Kawee TIRABORISUTE, Rayong (TH); Jettanan HOMCHANTHANAKUL, Rayong (TH); Bing Gwong LEUNG, Rayong (TH)

(21) Appl. No.: 18/575,763

(22) PCT Filed: Jun. 29, 2022
(86) PCT No.: PCT/IB2022/056059

§ 371 Date: Dec. 29, 2023

(30) Foreign Application Priority Data
Jun. 30, 2021 (TH) 12101003970

(51) Int. Cl. B62D 57/032; B25J 9/16; B25J 13/08

(52) U.S. Cl. CPC B62D 57/032; B25J 9/1664; B25J 13/085

(57) ABSTRACT

The invention relates to a walking robot comprising at least one moving module. Each moving module comprises a body, two legs, each leg connected to each opposite lateral side of the body, feet which is connected to the legs, and a joint provided on the body for connecting to another moving module in a detachable manner; a controller provided on each moving module for controlling a movement of the legs or the joint or both the legs and the joint; and a communication portion (3) provided on each moving module for communicating with the controller provided on another moving module. Each moving module can move in a lateral direction by a control of the controller and at least two moving modules can be connected together and move in a lateral/forward-backward direction by the control of the controller, which coordinates with the controller of another moving module through the communication portion.

### TECHNICAL FIELD

Engineering related to a walking robot.

### BACKGROUND OF THE INVENTION

A mobile robot finds its use in various applications at present, for example, land exploration, detection of device malfunction in industrial plants, exploration or operation in a restricted area where operators cannot access, such as, pipe, confined space, or low-oxygen area, or in a rescue. A walking robot is a type of robot commonly used in the aforementioned applications as it moves well on a bumpy or uneven surface, such as a rough, inclined surface, an area with different levels or obstructions, as well as moving in both vertical and horizontal directions.

However, most walking robots are developed to have a structure and movement that are suitable for a specific application and cannot be adjusted for different applications. For example, some robots are designed to be used on a rough surface but its movement cannot be adjusted for an application on a curved surface. Some robots may be developed to be able to move along a wall or a pipe wall but they are unable to move past horizontal obstructions, for example.

Therefore, there is a continuous effort to develop this type of robot to have a structure and functions that are suitable for applications. Examples of patent and utility model documents related to the development of the walking robot which have been disclosed are as follows.

CN 107336763 A discloses a multi-joint bionic crawling robot comprising two or more crawling units in sequential connection. Each of the crawling units comprises a bracket, a side-sway hydraulic cylinder hinged support, a thigh hydraulic cylinder hinged support, a hip joint hinged support, a cross hinged support, a leg part mechanism, and a hydraulic driving mechanism. The side-sway hydraulic cylinder hinged support, the thigh hydraulic cylinder hinged support, and the hip joint hinged support are arranged on the bracket and the cross hinged support is arranged nearby the thigh hydraulic cylinder hinged support. The leg part mechanism comprises hip joints, thigh joints, shank joints, and spherical feet sequentially connected to two sides of the bracket. The hydraulic driving mechanism is used for driving the leg part mechanism to swing.

CN 205469362 U discloses a transformer station inspection robot with pole-climbing function. The transformer station inspection robot comprises inspecting devices, a drive control module, and a crawling mechanism. The robot has a multi-section body and a body joint, which is used to link the adjacent body. The robot further comprises a joint motor mounted between the adjacent body unit and a pair of robot arms mounted on the body unit. The tip of the robot arms being equipped with a rotatory wheel and a wheel actuating mechanism. The body joint motor links are connected to each other through a related drive control module.

CN 1974300 A discloses a polypod walking robot capable of being disassembled and reconstructed. The robot consists of a first foot unit, a second foot unit, a third foot unit, a fourth foot unit, and a body supporting portion, wherein the body supporting portion has first to fourth upper beams and first to fourth lower beams.

Regardless of the currently available robots disclosed in the above patent and utility model documents, there remains a need for the development of a walking robot with improved characteristics and functionality, particularly a robot which can be used in a wider range of applications and can effectively move on different surfaces in different environments.

### SUMMARY OF THE INVENTION

The present invention relates to a walking robot comprising:
at least one moving module, wherein each moving module comprises a body, two legs, each leg connected to each opposite lateral side of the body, feet which is connected to the legs, and a joint provided on the body for connecting to another moving module in a detachable manner;
a controller provided on each moving module for controlling a movement of the legs or the joint or both the legs and the joint; and
a communication portion provided on each moving module for communicating with the controller provided on another moving module.

According to the present invention, each moving module can move in a lateral direction by a control of the controller and at least two moving modules can be connected together and move in a lateral or forward-backward direction by the control of the controller, which coordinates with the controller of another moving module through the communication portion.

An object of the present invention is to develop a walking robot having an appearance and component arrangement which can be adjusted to make the robot suitable for application in various environments. The robot according to the present invention can have a larger number or smaller number of the connected moving module and its feet can be adjusted to make it suitable for walking on different surfaces, including areas or regions that are difficult to access, such as a highly convex or concave region, a rough region with different levels, or a region with obstructions. Moreover, the robot according to the present invention can also be used in a wider range of applications, for example, the robot can be used for towing or pulling an object to make it move in a required direction by controlling the movement of the robot.

### BRIEF DESCRIPTION OF THE DRAWINGS

FIG. 1 is a diagram showing the main components and the connection of the main components of the robot according to the present invention.

FIG. 2 is a perspective view showing an exemplary embodiment of the moving module of the robot according to the present invention.

FIG. 3 is a front view showing an exemplary embodiment of the moving module of the robot according to the present invention.

FIG. 4 is a perspective view showing an exemplary embodiment of the feet of the robot according to the present invention.

FIG. 5 is a perspective view showing an exemplary embodiment of the robot according to the present invention which comprises three moving modules connected together.

FIG. 6 is a top view showing an exemplary embodiment of the robot according to the present invention which comprises three moving modules connected together.

FIG. 7 is a front view showing another exemplary embodiment of the moving module of the robot according to the present invention.

FIG. 8 is a cross-sectional view showing another exemplary embodiment of the feet of the robot according to the present invention.

FIG. 9 is a perspective view showing another exemplary embodiment of the robot according to the present invention which comprises four moving modules connected together.

### DETAILED DESCRIPTION

The details of the invention will be described hereinafter in conjunction with the accompanying drawings to achieve better understanding. The same reference numbers as in the drawings are used and explain identical or similar elements throughout the description of the invention.

Any aspects shown herein shall encompass the application to other aspects of the present invention as well, unless stated otherwise.

Technical and engineering terms used herein have the meanings as understood by a person of ordinary skill in the art, unless specified otherwise.

The terms “consist(s) of,” “comprise(s),” “contain(s),” and “include(s)” are open-end verbs. For example, a robot which “consist of,” “comprises,” “has,” or “includes” one or more components is not limited to only one or more components as mentioned, but also encompasses the components that are not mentioned.

FIG. 1 is a diagram showing the main components and the connection of the main components of the walking robot according to the present invention which comprises the moving module (1), wherein each module is provided with the controller (2) for controlling the movement of the moving module (1) and the communication portion (3) for communicating with the controller (2), which is provided on another moving module (1). Each moving module (1) can be connected together in a detachable manner through the joint (1.4), which is provided on each moving module (1).

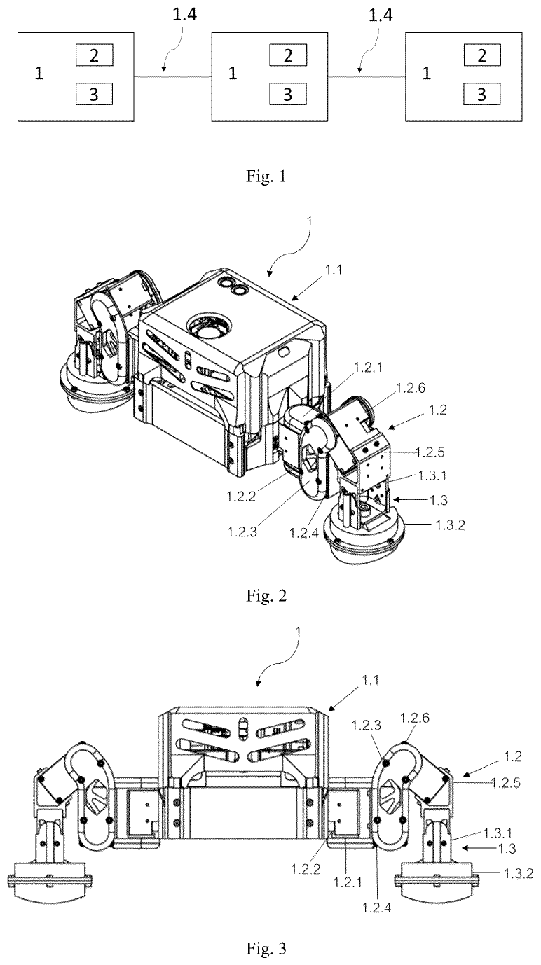

FIGS. 2-3 and 7 respectively show the first and second exemplary embodiments of the moving module (1) of the robot according to the present invention.

According to the present invention, each moving module (1) comprises the body (1.1), the two legs (1.2), each leg connected to each opposite lateral side of the body (1.1), the feet (1.3) which is connected to the legs (1.2), and the joint (1.4) which is provided on the body (1.1) for connecting to another moving module (1) in a detachable manner. Each moving module (1) has the controller (2), which is provided on each moving module (1) for controlling the movement of the legs (1.2) or the joint (1.4) or both the legs (1.2) and the joint (1.4), and the communication portion (3), which is provided on each moving module (1) for communicating with the controller (2) provided on another moving module (1).

According to exemplary embodiments shown in FIGS. 2-3 and 7, the body (1.1) may take the shape of a hollow square box. However, the shape of the body (1.1) is not limited to the hollow square box; other shapes such as a round or oval shape or any geometric shapes may also be taken.

Each moving module (1) of the robot according to the present invention which comprises the two legs (1.2) can move on its own. It can move in a lateral direction, that is, the direction where the legs (1.2) are provided, by the control of the controller (2). This type of robot which has only one moving module (1) is particularly suitable in a case where the robot is moving on both horizontal and vertical pipes.

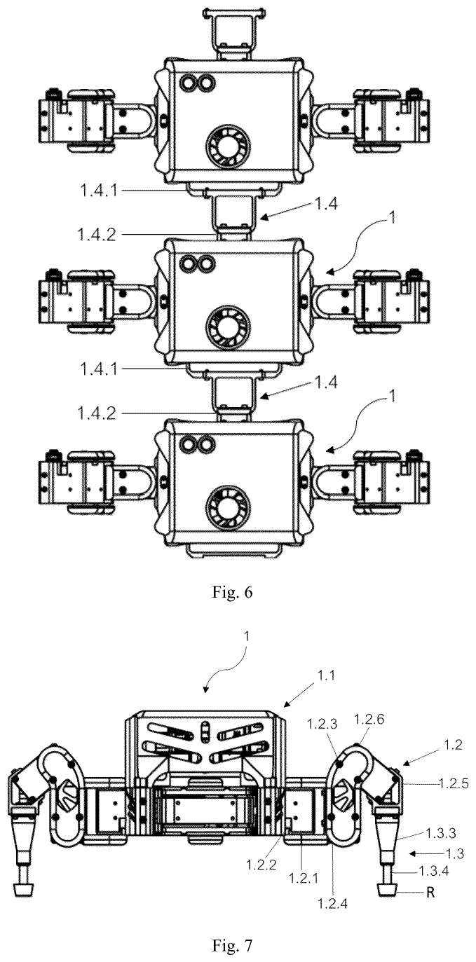

According to exemplary embodiments shown in FIGS. 5-6 and 9, the robot according to the present invention can comprise at least two moving modules (1) connected together to obtain a polypod robot, such as a 6-leg robot, which is formed by connecting together three moving modules (1) as shown in FIGS. 5-6, and an 8-leg robot, which is formed by connecting together four moving modules (1) as shown in FIG. 9. In this embodiment where the robot has multiple moving modules (1), the robot is able to move in both the lateral direction (that is, the direction where the legs (1.2) are provided) and a forward-backward direction (that is, the same direction as the connection of the moving module (1)) by the control of the controller (2) of each moving module (1) which coordinates with the controllers (2) of other moving modules (1) through the communication portion (3).

According to the above embodiment, the moving modules (1) which are connected and detached in an independent manner allow an adjustment of the appearance and the component arrangement of the robot by increasing/reducing the number of moving module (1) connected to make the robot suitable for the application with different surfaces and environments. Such robot having multiple moving modules (1) is particularly suitable, for example, in a case where the robot is used in a pipe or in a rough region with obstructions.

As shown in FIG. 6, the joint (1.4) of the moving module (1) comprises a pitch joint (1.4.1) for adjusting the rotation of a pitch angle and a yaw joint (1.4.2) for adjusting the rotation of a yaw angle and receiving a connection from the pitch joint (1.4.1) of another moving module (1). As exemplified in FIG. 6, the pitch joint (1.4.1) may be provided in front of the body (1.1) and the yaw joint (1.4.2) may be provided at the back of the body (1.1).

The provision of the pitch joint (1.4.1) and the yaw joint (1.4.2) enables each part of the body (1.1) of the connected moving module (1) to relatively rotate in an upward-downward direction and a left-right direction which allows the robot to more effectively adjust its movement in a backbone direction to correspond with the condition of the surface on which the robot is moving.

As a preferred example of the present invention, the pitch joint (1.4.1) and the yaw joint (1.4.2) are a free-rotating joint or a motor joint. In a case where the pitch joint (1.4.1) and the yaw joint (1.4.2) are the motor joint, said joints will be controlled by the controller (2) so that the rotation of each joint is accurate and corresponds with the condition of the surface on which the robot is moving.

According to a preferred embodiment, the pitch joint (1.4.1) and the yaw joint (1.4.2) comprise a torque sensor for measuring the generated motor torque and transmitting the data obtained from the measurement to the controller (2) to allow the controller (2) to control the rotation of the pitch joint (1.4.1) and the yaw joint (1.4.2). When the torque sensor of the pitch joint (1.4.1) and/or the yaw joint (1.4.2) detects the torque, the controller (2) will control the rotation of the pitch joint (1.4.1) and/or the yaw joint (1.4.2) to correspond with the detected torque. For example, when the moving module (1) at the front is moving on an inclined surface while the moving module (1) at the back is still moving on a flat surface, the generated toque is detected by the torque sensor of the pitch joint (1.4.1) and the controller (2) controls the rotation of the pitch joint (1.4.1) to rotate upward, which corresponds to the detected toque.

According to an additional preferred embodiment, the pitch joint (1.4.1) and the yaw joint (1.4.2) comprise a rotational position sensor mounted for measuring the rotation of the motor and transmitting the data obtained from the measurement to the controller (2) to allow the controller (2) to control the rotation of the pitch joint (1.4.1) and the yaw joint (1.4.2). The provision of the rotational position sensor allows the controller (2) to be aware of the distance the joint rotates.

As clearly shown in FIGS. 2-3 and 7, the legs (1.2) of the moving module (1) comprise proximal legs (1.2.1) with one end connected to the lateral side of the body (1.1) in a horizontally rotatable manner via a BC (body-coxa) joint (1.2.2); intermediate legs (1.2.3) with one end connected to the other end of the proximal legs (1.2.1) in a vertically rotatable manner via a CF (coxa-femur) joint (1.2.4); and distal legs (1.2.5) with one end connected to the other end of the intermediate legs (1.2.3) in a vertically rotatable manner via an FT (femur-tibia) joint (1.2.6) and the other end connected to the feet (1.3).

The determination of the components and the arrangement of elements of the legs (1.2) above result in the legs (1.2) that are similar to an insect's legs, wherein each leg (1.2) has six degrees of freedom.

Preferably, the BC joint (1.2.2), the CF joint (1.2.4), and the FT joint (1.2.6) comprise the rotational position sensor for measuring the rotation and transmitting the data obtained from the measurement to the controller (2). The provision of the rotational position sensor allows the controller (2) to be aware of the distance the BC joint (1.2.2), the CF joint (1.2.4), and the FT joint (1.2.6) rotate in order to learn the necessary movement data of the robot, such as the deviated movement direction relative to the initial movement direction.

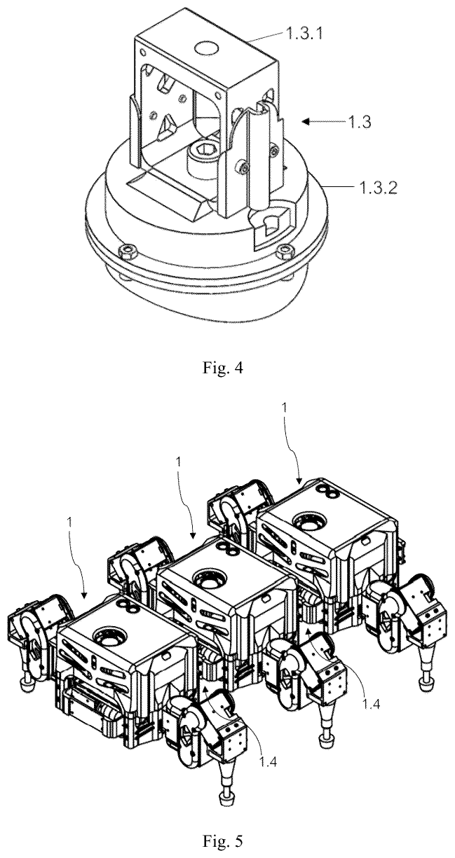

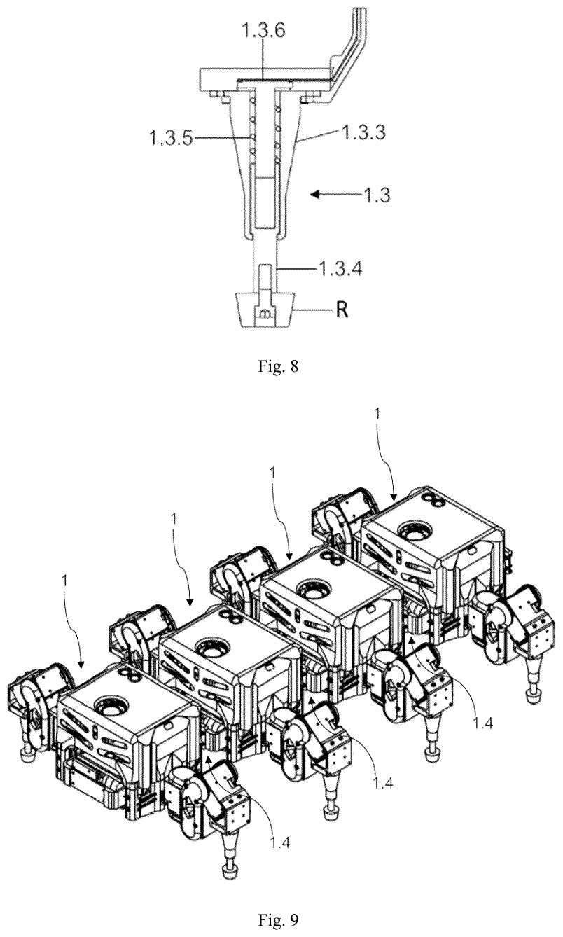

Exemplary embodiments of the feet (1.3) of the robot according to the present invention are shown in FIGS. 2-3 and 7 and shown more clearly in FIGS. 4 and 8, wherein the feet (1.3) comprise a case (1.3.1) connected to the legs (1.2) and a ground-contacting platform (1.3.2) connected to the case (1.3.1).

As an example, the ground-contacting platform (1.3.2) may have a circular or square shape when viewed from the top. However, the shape of the ground-contacting platform (1.3.2) may be different and can be adjusted for suitability in application.

The ground-contacting platform (1.3.2) may have a bottom surface profile that is any one of flat, convex, or concave or different forms of profile combined. As an example, the ground-contacting platform (1.3.2) may have a concave bottom surface profile with a radius of curvature ranging from 3-12 inches or any other ranges of the curvature radius that correspond with the curvature of the pipe where the robot will be used.

According to the above embodiment, a flat bottom surface profile of the ground-contacting platform (1.3.2) is preferably configured for a walk on a flat surface, such as a road surface, whereas a concave bottom surface profile of the ground-contacting platform (1.3.2) is preferably configured for a walk on a curved surface, such as an outer surface of the pipe.

As a preferred exemplary embodiment of the present invention, the ground-contacting platform (1.3.2) is made of an electromagnetic material. The use of the electromagnetic material will cause the ground-contacting platform (1.3.2) to be securely engaged to the surface where the robot is moving. In a case where the surface where the robot is moving is a metal material, such as a steel pipe, the walk of the robot can be controlled by supplying the electricity so that the ground-contacting platform (1.3.2) does not magnetism in order for the feet (1.3) to be lifted and cutting the electricity supply so that the ground-contacting platform (1.3.2) has magnetism in order for the feet (1.3) to be adhered to the steel pipe surface.

The feet (1.3) may further comprise a Hall-effect sensor for measuring the strength of the magnetic field and transmitting the data obtained from the measurement to the controller (2) to allow the controller (2) to control and adjust the movement of the robot.

According to the embodiments shown in FIGS. 7 and 8, the feet (1.3) comprise a hollow-rod case (1.3.3) connected to the legs (1.2) and a ground-contacting rod (1.3.4) with one end mounted in a stationary or axially movable manner inside the hollow-rod case (1.3.3) and the other end provided outside the hollow-rod case (1.3.3), wherein a tip portion of the ground-contacting rod (1.3.4) on the side provided outside the hollow-rod case (1.3.3) is made of an electromagnetic material.

The tip portion of the ground-contacting rod (1.3.4) on the side provided outside the hollow-rod case (1.3.3) may be encapsulated with a rubber material (R) to obtain a steady support and to increase the friction where the tip portion contacts with the surface.

The feet (1.3) may further comprise a spring (1.3.5) provided inside the hollow-rod case (1.3.3) adjacent to the ground-contacting rod (1.3.4) to absorb the impact of the ground-contacting rod (1.3.4) to prevent potential damage from excessive impact. As a preferred example, the spring (1.3.5) may be a compression spring.

The feet (1.3) may further comprise other types of sensor provided to achieve a more effective adjustment of the robot movement. Examples of suitable sensor to be assembled to the feet (1.3) are as follows.

The feet (1.3) may comprise a compression force sensor (1.3.6) provided inside the hollow-rod case (1.3.3) for measuring the compression force generated by the ground-contacting rod (1.3.4) and transmitting the data obtained from the measurement to the controller (2) to allow the controller (2) to control the rotation of the BC joint (1.2.2), the CF joint (1.2.4), and the FT joint (1.2.6) of the legs (1.2) based on the data obtained from the compression force sensor (1.3.6). The compression force detected by the compression force sensor (1.3.6) allows the controller (2) to be aware of whether or not the feet (1.3) has contacted with the ground so that the controller (2) can control the rotation of different joints of the legs (1.2) to correspond to the data obtained from the compression force sensor (1.3.6).

The feet (1.3) may comprise an infrared sensor which is mounted such that it faces the same direction as the robot's movement direction for detecting obstructions and transmitting the data obtained from the detection to the controller (2) to allow the controller (2) to control the rotation of the BC joint (1.2.2), the CF joint (1.2.4), and the FT joint (1.2.6) of the legs (1.2) based on the data obtained from the infrared sensor. For example, when the infrared sensor detects that the feet (1.3) is being obstructed in the direction of the robot's walk, the controller (2) will control the joints of the legs (1.2) so that the feet (1.3) are lifted above the obstruction to allow the robot to walk past it.

The feet (1.3) may comprise an ultrasonic sensor which is mounted such that it faces the same direction as the robot's movement direction for detecting obstructions and transmitting the data obtained from the detection to the controller (2).

Moreover, the moving module (1) may further comprise an inertial measurement unit (IMU) provided on the body (1.1) for measuring the movement of the body (1.1) and transmitting the data obtained from the measurement to the controller (2) to allow the controller (2) to control the rotation of the BC joint (1.2.2), the CF joint (1.2.4), and the FT joint (1.2.6) of the legs (1.2) based on the data obtained from the inertial measurement unit. For example, when the inertial measurement unit detects that the body (1.1) is moving in a direction of an inclined surface and is likely to overturn, the controller (2) will control the rotation of the joints of the legs (1.2) to redirect the walk back to a flat surface so that the body (1.1) can stand upright again.

The controller (2) of the robot according to the present invention comprises a movement signal generator (2.1) (not shown in the drawings) for creating a movement signal for the legs (1.2) and a processor (2.2) (not shown in the drawings) for processing the movement signal data and the movement data of the legs (1.2) and the joint (1.4), adjusting the movement signal based on the processed data, and transmitting the adjusted movement signal to the legs (1.2) and the joint (1.4).

According to a preferred embodiment of the present invention, the communication portion (3) is a wireless communication module selected from any one of Bluetooth module, Wi-Fi module, or both combined. Preferably, the communication portion (3) is a Wi-Fi module. However, the communication module is not limited to the wireless communication module, other forms of communication module may also be applied, for example, the communication portion (3) which is a wired communication module may be applied.

Each moving module (1) of the robot according to the present invention can move in the lateral direction, that is, the direction where the legs (1.2) are provided by controlling the movement of the CF joint (1.2.4) and the FT joint (1.2.6) to control the feet (1.3) to extend from the body (1.1) and retract to the body (1.1) to move to the left or right side and controlling the movement of the BC joint (1.2.2) to control the legs (1.2) to rotate towards the front or the back of the body (1.1) for a turning movement.

Moreover, when connecting more than two moving modules (1) together, the robot with multiple modules is able to move to the left or right side, as well as forward and backward, that is, the same direction as the connection of the moving module (1). The robot will move forward or backward when the movement of the BC joint (1.2.2) is controlled so that the legs (1.2) move forward or backward and the movement of the CF joint (1.2.4) is controlled to lift and lower the legs (1.2) and the movement of the FT joint (1.2.6) is controlled to extend and bend the legs (1.2).

The feet (1.3) of the robot can also be adjusted to make it suitable for application by adjusting the tip portion to become the ground-contacting rod (1.3.4) or the ground-contacting platform (1.3.2) with different forms of the bottom surface profile or to become the electromagnetic with or without the encapsulating material described above.

Therefore, the robot according to the present invention can be used in various applications and can effectively move on different surfaces in different environments. Examples of application of the robot according to the present invention are
an exploration or operation on a horizontal or vertical surface, which is any one of smooth, rough, inclined, concave, or convex surface or more than one of those combined;
an exploration or operation in an area having any one of horizontal or vertical obstructions or both combined; or
towing or pulling of a weighted object to move it from one point to another in the same direction as the robot's movement by connecting said weighted object to the moving module (1) at the joint (1.4) region either directly or through a fastening element or both combined, wherein the fastening element is any one of robe, wire, sling, or more than one of those combined.

The weight of the object which the robot can tow or pull depends on the number of the connected moving module (1). For example, in case of towing or pulling a lightweight object, the user may use a robot with only one or two moving modules (1) by using the tip portion of the ground-contacting rod (1.3.4) which is encapsulated with the rubber material (R). If the user wants to use the robot with the same number of moving module (1) to tow or pull a heavier object, the tip portion of the ground-contacting rod (1.3.4) which is made of the electromagnetic material may be used. Moreover, if the user wants the robot to tow or pull an even heavier object, the robot with a larger number of moving module (1) may be required, for example, a robot with more than four moving modules (1) connected together may be used in order to tow or pull said object.

The scope of the present invention is not limited by the above description of the aspects of the invention. Substitutions or analogues of the aspects of the present invention and any modifications or changes which are clearly apparent to a person skilled in the art, for example, a change of the material used to make or encapsulate the tip portion of the ground-contacting rod (1.3.4) or a change of the shape of the body (1.1) of the moving module (1), should be considered to be within the spirit, the scope, and the concept of the invention.

### BEST MODE OF THE INVENTION

Best mode of the invention is as described in the detailed description of the invention.

1. A walking robot comprising
at least one moving module, wherein each moving module comprises a body, two legs, each leg connected to each opposite lateral side of the body, feet connected to the legs, and a joint provided on the body for connecting to another moving module in a detachable manner;
a controller provided on each moving module for controlling a movement of the legs or the joint or both the legs and the joint; and
a communication portion provided on each moving module for communicating with the controller provided on another moving module;
wherein each moving module can move in a lateral direction by a control of the controller and at least two moving modules can be connected together and move in a lateral or forward-backward direction by the control of the controller, which coordinates with the controller of another moving module through the communication portion.

2. The walking robot according to claim 1, wherein the joint of the moving module comprises a pitch joint for adjusting a rotation of a pitch angle and a yaw joint for adjusting a rotation of a yaw angle and receiving a connection from the pitch joint of another moving module.

3. The walking robot according to claim 2, wherein the pitch joint and the yaw joint are a free-rotating joint or a motor joint.

4. The walking robot according to claim 3, wherein the pitch joint and the yaw joint comprise a torque sensor for measuring a generated motor torque and transmitting the data obtained from the measurement to the controller to allow the controller to control the rotation of the pitch joint and the yaw joint.

5. The walking robot according to claim 4, wherein the pitch joint and the yaw joint further comprise a rotational position sensor for measuring the rotation of the motor and transmitting the data obtained from the measurement to the controller to allow the controller to control the rotation of the pitch joint and the yaw joint.

6. The walking robot according to claim 1, wherein the legs of the moving module comprise proximal legs with one end connected to the lateral side of the body in a horizontally rotatable manner via a BC (body-coxa) joint; intermediate legs with one end connected to the other end of the proximal legs in a vertically rotatable manner via a CF (coxa-femur) joint; and distal legs with one end connected to the other end of the intermediate legs in a vertically rotatable manner via an FT (femur-tibia) joint and the other end connected to the feet.

7. The walking robot according to claim 6, wherein the BC joint, the CF joint, and the FT joint comprise the rotational position sensor for measuring the rotation and transmitting the data obtained from the measurement to the controller.

8. The walking robot according to claim 1, wherein the feet comprise a case connected to the legs and a ground-contacting platform connected to the case.

9. The walking robot according to claim 8, wherein the ground-contacting platform has a circular or square shape when viewed from the top.

10. The walking robot according to claim 8, wherein the ground-contacting platform has a bottom surface profile that is flat, convex, or concave.

11. The walking robot according to claim 10, wherein the ground-contacting platform has the bottom surface profile that is concave with a radius of curvature ranging from 3-12 inches.

12. The walking robot according to claim 8, wherein the ground-contacting platform is made of an electromagnetic material.

13. The walking robot according to claim 12, wherein the feet further comprise a Hall-effect sensor for measuring an electric field strength and transmitting the data obtained from the measurement to the controller to allow the controller to control and adjust the movement of the robot.

14. The walking robot according to claim 1, wherein the feet comprise a hollow-rod case connected to the legs and a ground-contacting rod with one end mounted in a stationary or axially movable manner inside the hollow-rod case and the other end provided outside the hollow-rod case.

15. The walking robot according to claim 14, wherein a tip portion of the ground-contacting rod on a side provided outside the hollow-rod case is made of an electromagnetic material.

16. The walking robot according to claim 14, wherein the tip portion of the ground-contacting rod on the side provided outside the hollow-rod case is encapsulated with a rubber material (R).

17. The walking robot according to claim 14, wherein the feet further comprise a spring provided inside the hollow-rod case such that it is adjacent to the ground-contacting rod.

18. The walking robot according to claim 14, wherein the feet further comprise a compression force sensor provided inside the hollow-rod case for measuring a compression force generated by the ground-contacting rod and transmitting the data obtained from the measurement to the controller.

19. The walking robot according to claim 8, wherein the feet further comprise an infrared sensor which is mounted such that it faces the same direction as the walking robot's movement direction for detecting obstructions and transmitting the data obtained from the detection to the controller.

20. The walking robot according to claim 8, wherein the feet further comprise an ultrasonic sensor which is mounted such that it faces the same direction as the walking robot's movement direction for detecting obstructions and transmitting the data obtained from the detection to the controller.

21. The walking robot according to claim 1, wherein the moving module further comprises an inertial measurement unit (IMU) provided on the body for measuring the movement of the body and transmitting the data obtained from the measurement to the controller.

22. The walking robot according to claim 1, wherein the controller comprises a movement signal generator for creating a movement signal for the legs and a processor for processing the movement signal data and the movement data of the legs and the joint, adjusting the movement signal based on the processed data, and transmitting the adjusted movement signal to the legs and the joint.

23. The walking robot according to claim 1, wherein the communication portion is a wireless communication module selected from any one of Bluetooth module, Wi-Fi module, or both combined.

24. The walking robot according to claim 23, wherein the communication portion is a Wi-Fi module.

25. The walking robot according to claim 1, wherein the walking robot is used for an exploration or operation on a horizontal or vertical surface, which is any one of smooth, rough, inclined, concave, or convex surfaces or more than one of those combined.

The walking robot according to claim 1, wherein the walking robot is used for an exploration or operation in an area having any one of horizontal or vertical obstructions or both combined.

27. The walking robot according to claim 1, wherein the walking robot is used for towing or pulling a weighted object to move it from one point to another in the same direction as the walking robot's movement by connecting said weighted object to the moving module at the joint region either directly or through a fastening element or both combined.

28. The walking robot according to claim 27, wherein the fastening element is at least one of: a robe, a wire, or a sling.
